(19) United States
(12) Patent Application Publication
(10) Pub. No.: US 2006/0145993 A1
(43) Pub. Date: Jul. 6, 2006

(54) Cholesteric liquid crystal display apparatus and method for driving cholesteric liquid crystal display device

(76) Inventor: Masaki Kitaoka, Minato-ku (JP)

Correspondence Address: RATNERPRESTIA, P O BOX 980, VALLEY FORGE, PA, 19482-0980, US

(21) Appl. No.: 11/295,854

(22) Filed: Dec. 7, 2005

(30) Foreign Application Priority Data
Dec. 7, 2004 (JP) 2004-353,672

(51) Int. Cl. G09G 3/36

(52) U.S. Cl. 345/94

(57) ABSTRACT

A method for driving a cholesteric liquid crystal display device in a fast rewriting speed and with a low electric power consumption resets the entire display area to a homeotropic oriented state by selecting all the common electrodes. It applies the common reset signals to all the common electrodes and the data reset signals to all the segment electrodes. Subsequently, the drive voltage waveform consisting of a common select signal and common hold signal is applied to respective common electrodes. The common select signal is applied for a while after the common select signal is applied to the last common electrode. The voltage waveforms applied to the common electrode and segment electrode consist of two levels of voltage, i.e., 0 volts and non-new voltage. The percentage that the non-new voltage is applied to both common electrode and segment electrode is made to the lowest level.

### BACKGROUND OF THE INVENTION

1. Field of the Invention

The present invention relates to a liquid crystal display (LCD) apparatus and a method for driving a liquid crystal display device, particularly to a cholesteric liquid crystal display apparatus and a method for driving a cholesteric liquid crystal display device in which voltage waveforms are applied to a liquid crystal layer from a plurality of common electrodes and segment electrodes oppositely crossed to each other.

2. Related Art

A cholesteric liquid crystal apparatus has advantages such that a bright display is possible using a reflection of outer light, a display content is not erased even when a power supply is off (i.e., a memory characteristic and a large capacity display may be realized in a simple matrix drive. Therefore, a cholesteric liquid crystal apparatus is recently attractive for the use of an electronic paper and sign board. Various devised drive methods have been proposed to a cholesteric liquid crystal display device due to its unique memory characteristic.

For example, a drive method has been disclosed in Japanese Patent publication No. 11-326,871 in which a reset voltages are first applied to all of common electrodes to cause the cholesteric liquid crystal to a focal conic state, and then select voltages are applied to common electrodes which are sequentially selected one by one. This drive method is referred to as a focal conic reset (FCR) method. This method is also referred to as a conventional method, because both common electrodes and segment electrodes may be driven by means of a conventional Super Twisted Nematic (STN) driver.

As an example, the voltage waveforms applied to the common electrodes and segment electrodes in order to drive a cholesteric liquid crystal device by means of the STN driver are shown in FIGS. 8A and 8B. FIG. 8A shows the voltage waveforms applied to the common electrode and the voltage waveforms applied to the segment electrode, respectively, and furthermore shows the composite voltage waveforms thereof. The composite voltage waveform corresponds to a voltage waveform applied to a pixel of the liquid crystal display device in an actual drive operation.

FIG. 8B shows the voltage waveforms applied to the common electrode and the voltage waveforms applied to the segment electrode arranged in a vertical direction with their time axes fitted for comparison.

An example of voltage waveforms actually applied to respective common electrodes and segment electrodes for driving a cholesteric liquid crystal display device configured by four common electrodes COM 1-4 and three segment electrodes SEG 1-3 is shown in FIG. 9.

Referring to the voltage waveforms shown in FIG. 9 applied to the common electrodes, each waveform includes a reset time interval and rewrite time interval. The reset time interval consists of a planar reset time interval and a focal conic reset time interval. If the planar reset time interval is not provided, a display after a rewrite operation has an effect of a display prior to the rewrite operation. In the planar reset time interval, all the common electrodes are selected together for a time interval longer than that of the select voltage waveform applied to the common electrode during a rewrite time interval, and ON voltage waveforms are applied to all the segment electrodes. In this manner, a cholesteric liquid crystal in the entire display area of a panel is reset to a planar state. In the focal conic reset time interval, all the common electrodes are selected together for a time interval shorter than that of the select voltage waveform applied to the common electrode during a rewrite time interval, and the time interval during which an OFF voltage waveform is applied and the time interval during which voltages are not applied to all the common electrodes and all the segment electrodes are alternately repeated. In this manner, a cholesteric liquid crystal which has been reset in the entire display area of a panel is reset to a focal conic state.

In the rewrite time interval, the common electrode to which a select voltage waveform has been applied is selected so that the pixel to which the ON voltage waveform is applied from the segment electrode is caused to be a planar state, and the pixel to which the OFF voltage waveform is applied from the segment electrode is cause to be a focal conic state. In the case of a panel comprising n common electrodes, the voltage waveform applied to a common electrode during a rewrite time interval consist of one select voltage waveform and (n−1) non-select voltage waveform. A rewrite operation is carried out in such a manner that the select voltage waveforms are shifted not so as to be overlapped every common electrode.

The difference between the a common drive voltage waveform applied to a common electrode and a segment drive voltage waveform applied to a segment electrode is applied to a pixel of the liquid crystal display device. As one example, the voltage waveform applied to the pixel (COM 2, SEG 1) in FIG. 9 is shown in FIG. 10.

However, in a conventional method using a generalized STM driver, an extremely large electric power is required at a reset timing for the case of a panel having a large area and a number of pixels, because the rush currents are large at an instant when all the common electrodes are selected together and at an instant when the ON or OFF voltage waveforms are applied at the same time to all the segment electrodes. Also, regarding a rewrite time interval, the width of a select voltage waveform applied to a common electrode should be set to be 3 msec or more in order to implement a useful display having a high reflectance in a planar oriented state and a high contrast. This leads to a defect of a low rewrite speed of a panel.

In view of this problem, U.S. Pat. No. 5,748,277 has proposed a drive method referred to as a Dynamic Drive Scheme (DDS) method. A drive voltage waveform in the DDS method is shown in FIG. 11. The voltage waveform includes a reset time interval to cause a liquid crystal to a homeotropic state, a select time interval to determine that the final oriented state is to be a planar state, a focal conic state, or an intermediate state therebetween, a hold time interval to hold an oriented state determined in the select time interval, and a non-select time interval required for a simple matrix drive operation.

As an example, a timing of voltages applied to the common electrodes for driving a simple matrix liquid crystal panel comprising 16 common electrodes is shown in FIG. 12. A reset voltage waveform, a select voltage waveform, a hold voltage waveform, and a non-select voltage waveform are sequentially applied to the common electrodes while shifting a time interval which is equal to a select time interval. It is noted that the reset, select, hold, and non-select voltage waveforms correspond to the voltage waveform in the reset, select, hold, and non-select time intervals, respectively. The DDS method is suitable for a high speed drive, because the select time period may be smaller than 1 msec in a room temperature.

In an interval A in FIG. 12, it is required that the reset voltage waveforms are applied to the common electrodes COM 11-16, the select voltage waveform to the common electrode COM 10, the hold voltage waveforms to the common electrodes COM 4-9, and the non-select voltage waveforms to the common electrodes COM 1-3. That is, in order to DDS drive the cholesteric liquid crystal panel, a common driver IC used for the common electrodes is required to comprise a function to output four levels of voltage waveforms such as the reset, select, hold, and non-select voltage waveforms at the same time.

SID'97 Digest, 899 (1997) has disclosed voltage waveforms to be applied to common electrodes and segment electrodes in a cholesteric liquid display device for a DDS drive, the waveforms thereof are shown in FIGS. 13A and 13B.

In FIG. 13A, on upper column there are shown the voltage waveforms applied to common electrodes, on left column the voltage waveforms applied to segment electrodes, on middle column and lower column except the left column composite voltage waveforms thereof applied between the common electrodes and the segment electrodes, the composite voltage waveform being the difference between the voltage waveform applied to the common electrode and that applied to the segment electrode.

In FIG. 13B, the voltage waveform applied to the common electrode, and the voltage waveforms applied to the segment electrodes are arranged in a vertical direction with their time axes fitted for comparison. It is appreciated from FIG. 13B that each of the reset, select, hold and non-select voltage waveforms includes four unit intervals w1-w4. It is understood that four levels of voltages are required every unit interval. In the DDS drive method, therefore, a driver IC is required in which four levels of voltages are always outputted at the same time every unit interval.

FIG. 14 shows one example of voltage waveforms actually applied to respective common electrodes and segment electrode for driving a cholesteric liquid crystal display device comprising four common electrodes and three segment electrodes by the voltage waveforms shown in FIG. 13A. FIG. 15 shows the voltage waveform applied to the pixel (COM 2, SEG 1) in FIG. 14.

For simplicity of the figures, the number of reset voltage waveforms is selected to be five and the number of hold voltage waveforms is selected to be four. In an actual drive operation, it is preferable that the number of reset voltage waveforms is selected to be 20-100, i.e., the total reset time interval is 20-50 msec, and the number of hold voltage waveform is selected to be 10-60, i.e., the total hold time interval is 10-30 msec.

It is appreciated from FIGS. 13A and 13B that the difference between the voltage applied to a common electrode and the voltage applied to a segment electrode is large in the reset time interval and hold interval. Also, when the low voltage side is not zero volts, i.e., is not grounded, a charge stored in a liquid crystal flows reversely, so that a comparatively large electric power is consumed in order to maintain the voltage applied to respective electrodes at a fixed value.

In the intervals w1 and w2 shown in FIG. 13B, a high voltage is applied to the segment electrodes, respectively. As the common electrodes are grounded in a reset time interval, a fixed voltage may be applied to the segment electrodes. However, in the interval w3, a high voltage from the common electrode and a low voltage (not zero volts) from the segment electrode are applied to the liquid crystal display device. At this time, an electric charge is stored in the liquid crystal display device. When the electric charge stored in the device reaches to a saturated value, the electric charge flows back to each electrodes. This is also applicable to a hold time interval. The reverse-flows of an electric charge are generated 20-100 times in a reset time interval and 10-60 times in a hold time interval. Therefore, a large electric power is required to maintain the voltage applied to respective electrodes at a suitable value.

SID'01 Digest, 882 (2001) has disclosed a method for driving the common electrode only by a select voltage waveform and hold voltage waveform, after resetting a cholesteric liquid crystal corresponding to the entire display area of the device to a homeotropic state.

The waveforms in this method are shown in FIGS. 16A and 16B, i.e., a select voltage waveform and hold voltage waveform applied to a common electrode, and an ON and OFF voltage waveforms applied to a segment electrode.

FIG. 17 shows an example of voltage waveforms actually applied to respective common electrodes and segment electrode for driving a cholesteric liquid crystal display device comprising four common electrodes and three segment electrodes by the voltage waveforms shown in FIG. 16A. Also, the voltage waveform applied to the pixel (COM 2, SEG 1) in FIG. 17 is shown in FIG. 18.

Each of the select voltage waveform and hold voltage waveform applied to a common electrode, and the ON and OFF voltage waveforms consists of 0 volts (ground) and a voltages other than 0 volts. The voltages may be easily maintained at predetermined values, because an electric charge stored in the liquid crystal display device by the applied voltage flows to the grounded electrode.

However, respective hold time intervals after applying the select voltage waveforms are different every common electrode, so that it is required to strictly control the voltage other than 0 volts in order to realize a uniform display across the entire display area of the liquid crystal display device. Furthermore, the starting voltages of the ON and OFF voltage waveforms applied to a segment electrode are different so that it is difficult to obtain a uniform display across the entire display area of the liquid crystal display device.

Not only the voltage waveform applied to a common electrode and the voltage waveform applied to a segment electrode, but also a composite voltage waveform thereof, i.e., the voltage waveform applied to a pixel are varied hard, so that the electric power consumed by a drive operation becomes large as the frequency is increased. As a result, the conventional drive method is not suitable when a battery is used for a power supply.

### SUMMARY OF THE INVENTION

An object of the present invention is to provide a method for driving a cholesteric liquid crystal display device in a fast rewriting speed and with a low electric power consumption.

Another object of the present invention is to provide a cholesteric liquid crystal display apparatus which may be driven by only two levels of voltages consisting of 0 volts and a voltage other than 0 volts.

A first aspect of the present invention is a method for driving a cholesteric liquid crystal display device in which pixels are formed in a matrix manner by a plurality of common electrodes provided on one glass substrate, a plurality of segment electrodes provided in a direction orthogonal to that of the common electrodes on the other glass substrate arranged oppositely to the one glass substrate, and a cholesteric liquid crystal provided between the common electrodes and the segment electrodes, a planar state, focal conic state or intermediate state thereof of the liquid crystal being maintained by a memory characteristic when a voltage is not applied to the pixel, and the orientation of the liquid crystal being controlled by the difference between a voltage applied to the common electrode and a voltage applied to the segment electrode.

The method comprises the steps of:

resetting the liquid crystal of all the pixels to a homeotropic state by applying a common reset signal and a data reset signal to all the common electrodes and all the segment electrodes, respectively, to apply a reset signal consisting of the difference between the common reset signal and the data reset signal to the liquid crystal of all the pixels;

determining the orientation of each liquid crystal forming all the pixels by the steps of,
selecting one of the common electrodes as a common selected electrode and others thereof as common non-selected electrodes,
applying a common select signal and common hold signal to the common selected electrode and common non-selected electrode, respectively, and applying a data signal to the segment electrode in synchronizing with the common select signal, thereby applying a select signal consisting of the difference between the common select signal and the data signal to the liquid crystal forming the pixel on the common selected electrode to determine the final orientation of the liquid crystal, and applying a hold signal consisting of the difference between the common hold signal and the data signal to the liquid crystal forming the pixel on the common non-selected electrode,
subsequently select the next one of the common electrodes as a common selected electrode and others thereof as common non-selected electrodes to determine the final orientation of the liquid crystal forming the pixel on the common selected electrode by implementing the above steps, and
repeating the just above step; and

holding the orientation of the liquid crystal of all the pixels determined by the above steps applying the common hold signal and the data signal to all the common electrodes and all the segment electrodes, respectively, to apply a hold signal consisting of the common hold signal and the data signal to the liquid crystal of all the pixels;

wherein the common hold signal is 0 volts, and the common select signal and data signal each consist of two levels of voltages consisting of 0 volts and a voltage other than 0 volts.

A rewrite operation is ended after the completion of a series of steps, i.e., a step of resetting the liquid crystal (the time interval thereof is referred to as a resent time interval), a step of determining the orientation of the liquid crystal, i.e., a step of determining the display state (the time interval thereof is referred to as a display state determine time interval), and a step of holding the orientation of the liquid crystal, i.e., a step of holding an entire area to a predetermined oriented state (the time interval thereof is referred to as an entire area hold time interval). In this case, the time interval during which the voltage applied to a common electrode and the voltage applied to a segment electrode are conflicting is only the time interval during which a common select signal per pixel is applied to a common electrode. Therefore, a signal applied to a common electrode and a signal applied to a segment electrode may be maintained at an ideal state. As an electric charge stored in the liquid crystal display device during a drive operation passes to the grounded electrode, the distortion of a drive voltage waveform may be suppressed to the lowest level.

As a data reset signal is set to be always 0 volts, there is no conflict during a reset time interval between the voltage applied to a common electrode and the voltage applied to a segment electrode, which is furthermore ideal.

Also, as the distortion of a drive voltage waveform may be suppressed to the lowest level, the consumption of an electric power by a drive voltage waveform become lowest.

On the other hand, a data signal applied to a segment electrode, i.e., a signal for causing a liquid crystal to a planar orientation and a signal for causing a liquid crystal to a focal conic orientation each consist of two levels of voltages, i.e., 0 volts and a voltage other than 0 volts. It is preferable that the time interval of the data signal other than 0 volts is in the range of 60-80% to the which of the data signal.

If the time interval other than 0 volts is smaller than 60% of the width of the data signal, then a drive voltage is require to be high. If the time interval other than 0 volts is larger than 40% of the width of the data signal, then a strict control is required for a drive voltage and a display quality is sensitive to a temperature variation.

If the time interval other than 0 volts is larger than 80% of the width of the data signal, then the voltage in a reset time interval is insufficient when the voltage of a hold time interval is set to a suitable value, and the voltage of a hold time interval is insufficient when a voltage enough for a reset is provided. This causes a display difficult.

It is also preferable that the starting voltage of the data signal to cause the final orientation of the cholestric liquid crystal to a planar oriented state is equal to the starting voltage to cause the final orientation of the cholesteric liquid crystal to a focal conic oriented state.

A rewrite operation of a display content for the liquid crystal display is possible according to the above-described technique, but the positive/negative valance of the voltage waveform applied to a pixel is not good. The increase of a DC component of the voltage waveform applied to a pixel has a bad influence upon the liquid crystal corresponding to the pixel, resulting in the decomposition of the liquid crystal in certain cases. According to the present invention, a common reset signal may be determined in such a manner that the time interval during which the voltage other the 0 volts is applied to the common electrode is equal to the time interval during which the voltage other than 0 volts is applied to the segment electrode.

A common reset signal may be provided with 0 volts time interval to remove an effect of the entire display content in an rewrite operation of the liquid crystal display device.

A second aspect of the present invention is a cholestric liquid crystal display apparatus. The apparatus comprises:

a liquid crystal display device in which a plurality of pixels are formed at portions crossed by a plurality of common electrode and a plurality of segment electrodes;

a common driver for applying drive voltage waveforms from the common electrodes to the cholesteric liquid crystal display device, the drive voltage waveforms including a common reset signal to cause the cholesteric liquid crystal to a homeotropic state and a common select signal to select the final orientation of the cholesteric liquid crystal;

a segment driver for applying drive voltage waveforms from the segment electrodes to the cholesteric liquid crystal display device, the drive voltage waveforms including a data signal to cause the final orientation of the cholesteric liquid crystal to a planar state and a data signal to cause the final orientation of the cholesteric liquid crystal to a focal conic state; and

a controller for controlling the common driver and segment driver;

wherein the controller controls the common and segment driver in such a way that a display content is rewritten by

switching two levels of voltages, consisting 0 volts and a voltage other than 0 volts to apply voltages to all the common electrodes and all the segment electrodes,

resetting the liquid crystal of all the pixels to a homeotropic state by applying a common reset signal and a data reset signal to all the common electrodes and all the segment electrodes, respectively,

selecting one of the common electrodes as a common selected electrode, applying a common select signal to the common selected electrode, applying 0 volts to others of the common electrodes, applying a data signal to the segment electrode in synchronizing with the common select signal, repeating these steps to apply the common select signal to all the common electrodes, and applying 0 volts and data signals to all the common electrodes and all the segment electrodes, respectively.

According to the present invention, the drive method may be implemented, in which a rewrite speed of a cholesteric liquid crystal is fast and consumption of an electric power is small, and the cholesteric liquid crystal display apparatus may also be implemented, in which both common electrodes and segment electrode may be driven only by two levels of voltages consisting of 0 volts and a voltage other than 0 volts.

### BRIEF DESCRIPTION OF THE DRAWINGS

FIG. 1 shows a schematic diagram of the structure of a cholesteric liquid crystal display apparatus in accordance with the present invention.

FIG. 2 shows a schematic view of a cholesteric liquid crystal display device used in a cholesteric liquid crystal display apparatus in accordance with the present invention.

FIG. 3A shows two types of signals applied to a common electrode, and two types of data signals applied to a segment electrode.

FIG. 3B shows signals arranged a vertical direction with their time axes fitted.

FIG. 3C shows signals arranged in a horizontal direction with their voltage axes fitted.

FIG. 4 shows one example of voltage waveforms actually applied to respective common electrodes and segment electrode for driving a cholesteric liquid crystal display device by the voltage waveforms shown in FIG. 3A.

FIG. 5 shows one example of the voltage waveform applied to the pixel in FIG. 4.

FIG. 6 shows a schematic view of time intervals the voltage waveforms applied to the liquid crystal display device.

FIG. 7 shows the voltage waveforms applied to the liquid crystal display device in the embodiment.

FIG. 8A shows the voltage waveforms applied to the common electrode and segment electrode for the FCR drive operation.

FIG. 8B shows the voltage waveforms in FIG. 8A arranged in a vertical direction with their time axes fitted for comparison.

FIG. 9 shows one example of the voltage waveforms applied to respective common electrodes and segment electrode for driving a cholesteric liquid crystal display device by the voltage waveforms shown in FIG. 8A.

FIG. 10 show one example of the voltage waveform applied to the pixel in FIG. 9.

FIG. 11 shows a drive voltage waveform in the DDS method.

FIG. 12 shows a timing of voltages applied to the common electrodes.

FIG. 13A shows the voltage waveforms applied to common electrodes and segment electrodes for the DDS drive operation.

FIG. 13B shows the voltage waveforms arranged in a vertical direction with their time axes fitted.

FIG. 14 shows one example of the voltage waveforms applied to respective common electrodes and segment electrode for driving a cholesteric liquid crystal display device by the voltage waveforms shown in FIG. 13A.

FIG. 15 shows the voltage waveform applied to the pixel in FIG. 14.

FIG. 16A shows the voltage waveforms applied to common electrodes and segment electrodes for the DDS drive operation.

FIG. 16B shows the voltage waveforms arranged in a vertical direction with their time axes fitted.

FIG. 17 shows one example of the voltage waveforms applied to respective common electrodes and segment electrode for driving a cholesteric liquid crystal display device by the voltage waveform shown in FIG. 16A.

FIG. 18 shows the voltage waveform applied to the pixel in FIG. 17.

### BEST MODE FOR CARRYING OUT THE INVENTION

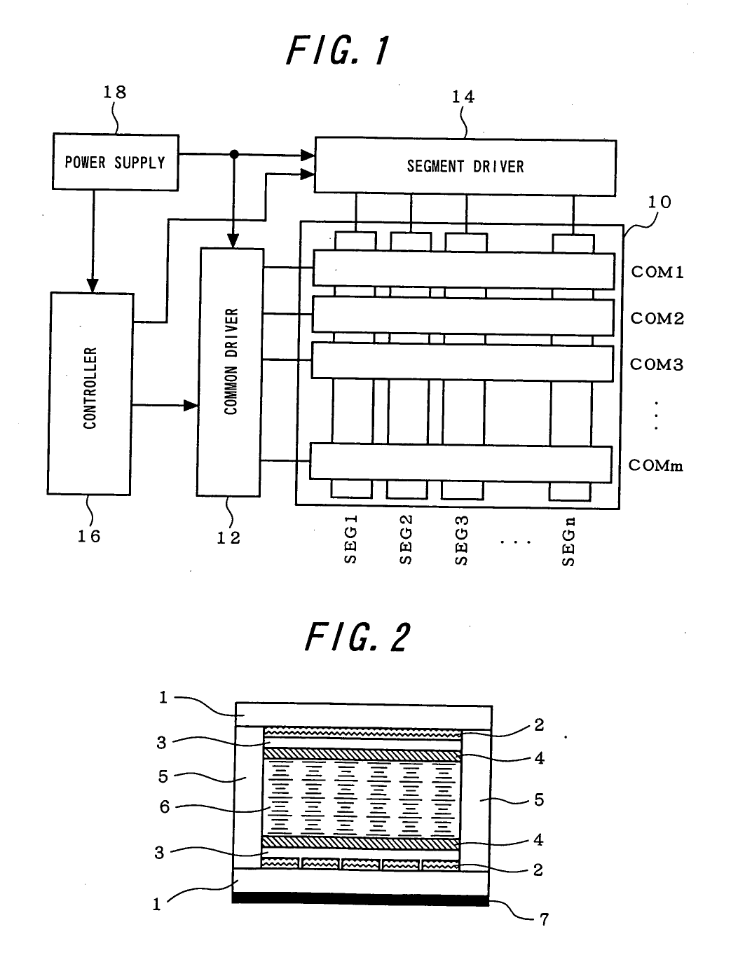

FIG. 1 is a schematic diagram of the structure of a cholesteric liquid crystal display apparatus in accordance with the present invention. The cholesteric liquid crystal display apparatus comprises a cholesteric liquid crystal display device 10 driven in matrix by means of a plurality of common electrodes COM 1, COM 2, . . . and a plurality of segment electrodes SEG 1, SEG 2 . . . , both of them being oppositely crossed, and a mechanism for writing a display content in accordance with a drive method of the present invention.

The mechanism comprises a common driver 12, a segment drive 14, a controller 16, and a power supply 18.

The common electrodes of the cholesteric liquid crystal display device 10 are connected to the outputs of the common driver 12, and the segment electrodes to the outputs of the segment driver 14. Voltages are applied from the common driver 12 to the common electrodes COM 1, COM 2, . . . and from the segment driver 14 to the segment electrodes SEG 1, SEG 2 . . . , respectively, based on the instruction from the controller 16. The difference between the voltage of a common electrode and the voltage of a segment electrode is applied to a pixel of the liquid crystal display device 10.

FIG. 2 shows a schematic view of a cholesteric liquid crystal display device 10 used in a cholesteric liquid crystal display apparatus in accordance with the present invention. In FIG. 2, the substrate 1 consists of quartz glass, soda-lime glass having a film for preventing the dissolution of alkali ion, a plastic film such as polyether sulfon and polyethylene terephthalate, or a plastic substrate such as polycarbonate.

The electrode layer 2, the electric insulating film 3, and the orientation layer 4 are stacked in this order on the substrate 1, and then the electrode layer 2 is patterned to form a plurality of linear electrodes. In this manner, two transparent substrates are fabricated. These two transparent are laminated to each other by the main seal 5 to fill the cholesteric liquid crystal material 6 in a space enclosed by the main seal.

While ITO (Indium Tin Oxide) is preferable for the material of the electrode 2, conductive metal oxide such as SnO₂ and conductive material such as conductive resin like polypyrrole and polyaniline may also be used.

Insulating material such as SiO₂ and TiO₂ is preferable for the electrical insulating film 3 which is provided for preventing a short circuit between the opposite electrodes, but it is not necessary required.

While polyimide resin is preferable for the orientation layer 4, surface modifier or resin containing silicon, fluorine or nitrogen may be used. Also, either a horizontal orientation layer or a vertical orientation layer may be used as an orientation layer.

The cholesteric liquid crystal 6 preferably consists of nematic liquid crystal having a positive dielectric anisotropy and 10-50 weight % of chiral material. As the nematic liquid crystal to be used, cyanobiphenyl-type, phenylcychohexyl-type, phenylbenzonate-type, and cyclohexylbenzoate-type, and the like are preferable, but are not limited thereto.

Cholesteric liquid crystal may be dispersed in polymer matrix or capsulated. The selected reflective wavelength of a cholesteric liquid crystal may be not only in visible area but also infrared area.

The light absorbing film 7 may be provided on the side opposite to the viewing side. The color of the light absorbing film is preferably black or blue, but is not limited thereto. An optical film such as a reflection film, deflection film, and phase difference film may be attached in place of the light absorbing film 7.

On the viewing surface, a deflection film, a phase difference film, or an optical film having a function of ultraviolet shielding may be attached.

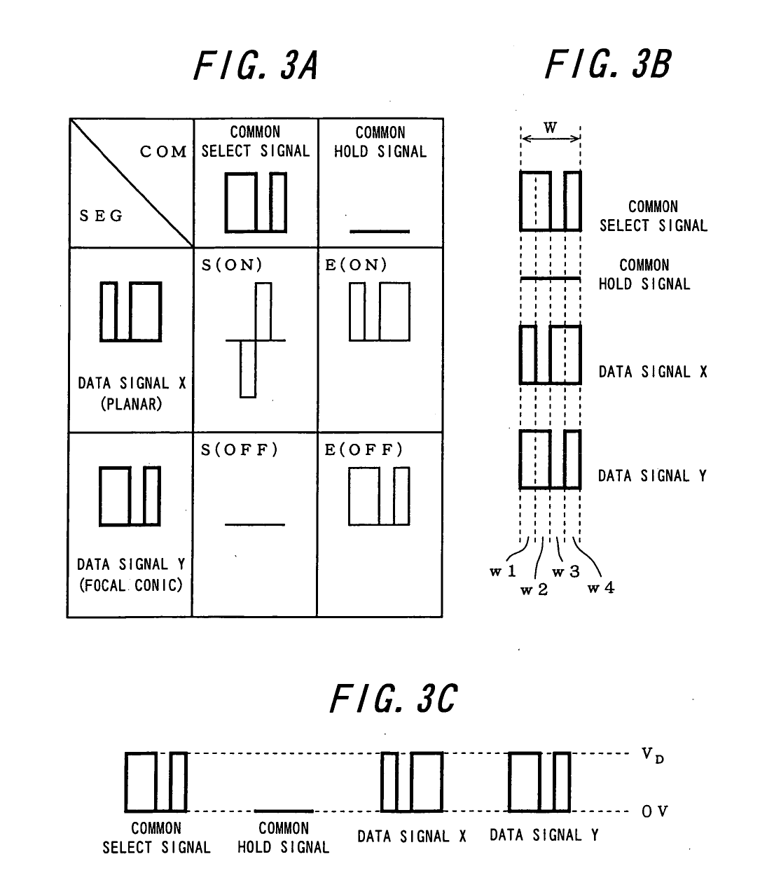

An embodiment of a drive method according to the present invention based on a DDS method will now be described. FIGS. 3A, 3B and 3C show a common select signal and common hold signal applied to a common electrode, and data signals applied to a segment electrode. The data signal X is a signal for causing the orientation of a liquid crystal to a planar orientation, and the data signal Y is a signal for causing the orientation of a liquid crystal to a focal conic orientation. FIG. 3A shows two types of signals applied to a common electrode, two types of data signals applied to a segment electrode, and composite signals thereof. FIG. 3B shows the two types of signals applied to a common electrode and the two types of data signals applied to a segment electrode, which are arranged a vertical direction with their time axes fitted for comparison these signals. FIG. 3C shows the two types of signals applied to a common electrode and the two types of data signals applied to a segment electrode, which are arranged in a horizontal direction with their voltage axes fitted for comparison these signals. Apparent from FIG. 3B, each of the common select signal and common hold signal applied to a common electrode, and data signals X and Y applied to a segment electrode includes four unit intervals w1-w4. Each of these signals has the same width W.

All the unit intervals w1-w4 of the common hold signal are always 0 volts, and each of the common select signal, and the data signals X and Y consists of two levels of voltages, i.e., 0 volts and voltage V_{D} other than 0 volts. Apparent from FIG. 3B, each of the common select signal, and the data signals X and Y has a time interval, the voltage during the interval being V_{D} and the interval having 75% of the width W.

It is also appreciated that respective starting voltages of the data signals X and Y are equal. In this manner, a uniform display across the entire display area of a liquid crystal display device may be realized.

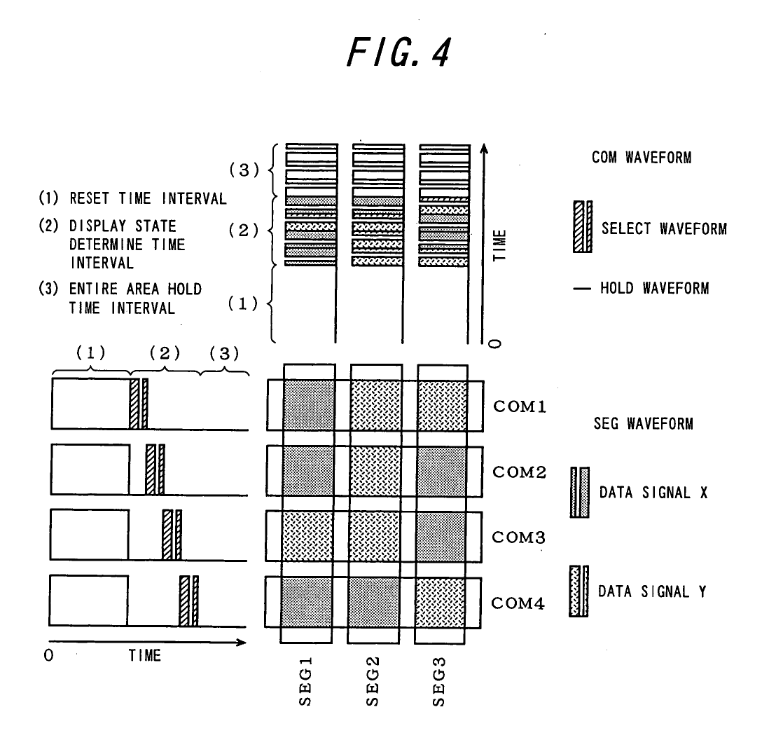

FIG. 4 shows one example of voltage waveforms actually applied to respective common electrodes and segment electrode for driving a cholesteric liquid crystal display device by the voltage waveforms shown in FIG. 3A.

First, all of the common electrodes are selected together to reset the entire display area to a homeotropic state. At this time, the common reset signals are applied to all the common electrodes, respectively, and the data reset signals are applied to all the segment electrodes, respectively. In FIG. 4, the signals in the reset time intervals (1) are these common reset signal and data reset signal. The data reset signal is always 0 volts during the resent time interval.

Subsequently, in the same manner as the FCR driving, the drive voltage waveforms each consisting of a common select signal and common hold signal are applied to respective common electrodes while shifting the width of the common select signal. The common hold signal is applied for a while after applying the common select signal to the last common electrode. On the other hand, the drive voltage waveforms including the data signal X for causing the orientation of a liquid crystal to a planar orientation and the data signal Y for causing the orientation of a liquid crystal to a focal conic orientation are applied to the respective segment electrodes based on a display content.

For simplicity of the figure, an entire area hold time interval after applying the common select signal to the last common electrode corresponds to three times the interval of a common hold signal, but the present invention is not limited thereto.

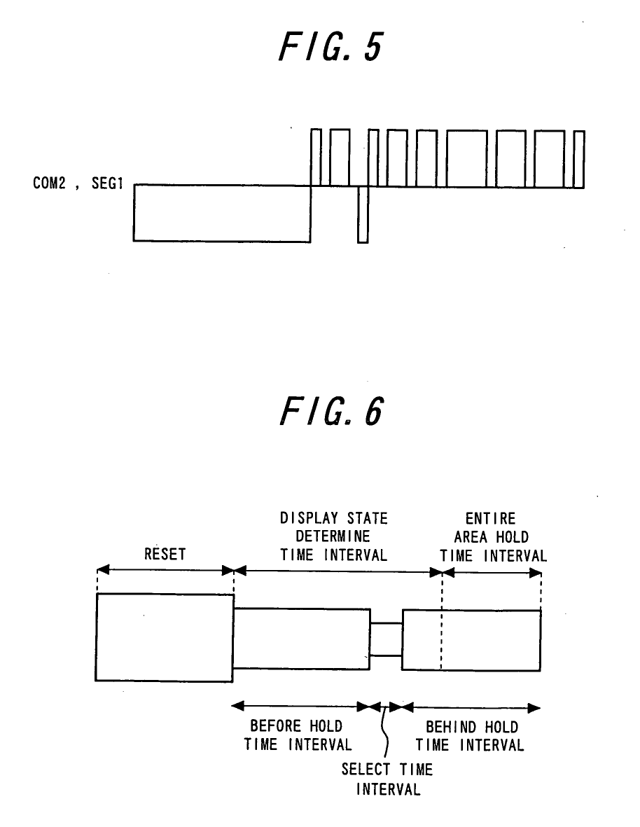

The difference between the common drive voltage waveform applied to a common electrode and the segment drive voltage waveform applied to a segment electrode is applied to a pixel of the liquid crystal display device. FIG. 5 shows one example of the voltage waveform applied to the pixel (COM 2, SEG 1) in FIG. 4.

The common reset signal applied to the common electrode during a reset time interval may be regulated so that the positive/negative valance of the waveform shown in FIG. 5 is held. For the case of FIG. 4, for example, the common hold signal consists of six waveforms, and the time interval of the data signal other than 0 volts is 75% of the data signal width W shown in FIG. 3B. Therefore, assuming W is 1 msec, the time interval of the common hold signal other than 0 volts is 1 msec×6×0, 75=4, 5 msec. As a result, if the reset time interval is set to 4.5 msec, then the positive/negative valance of the waveform shown in FIG. 5 may be maintained.

A reset time interval may be calculated in a manner described above. However, for the case of a liquid crystal display device having less common electrodes, the time enough for resetting the liquid crystal to a homeotropic state is not obtained by the calculated value described above. In this case, a reset time interval may be added by providing a time interval other than 0 volts to a data reset signal and 0 volts time interval to a common reset signal, or by extending a reset time interval while extending the hold time interval and holding the valance with the reset time interval.

While the matrix structure comprising four common electrodes and three segment electrodes has been illustrated in FIG. 4, the number of electrodes are not limited thereto according to the present invention. As a cholesteric liquid crystal has a memory characteristic there is no limitation theoretically for the numbers of common electrodes and segment electrodes. However, the common reset signals applied to all the common electrodes during a reset time interval are determined so that the positive/negative valance of the voltage waveform applied to a pixel is held. Therefore, larger the number of common electrodes, the longer the reset time interval is. Also, as the number of common electrodes become large, the drive voltage should be strictly determined. Then, the number of common electrodes is preferably 160 or less.

A concrete example will be described hereinafter. The cholesteric liquid crystal display device 10 shown in FIG. 2 was fabricated by using liquid crystal material made of the mixture of 0.7 grams of nematic liquid crystal material RPD-84202 commercially available by DAINIPPON INK AND CHEMICALS INCORPORATED, 0.2 grams of chiral material CB-15 commercially available by Merk & Co., Inc., and 0.1 grams of chiral material CNL-617R commercially available by ASAHI DENKA Co., Ltd. The thickness of the liquid crystal layer was 4.5 μm.

To the fabricated cholesteric liquid crystal display device, the signals shown in FIGS. 3A, 3B and 3C and DDS drive voltage waveforms shown in Table 1 formed by the common reset and data reset signals were applied as shown in FIG. 6. In FIG. 6, a display state determine time interval consists of a before hold time interval, a select time interval and a part of the behind hold time interval, and a entire area hold time interval is a part of the behind hold time interval.

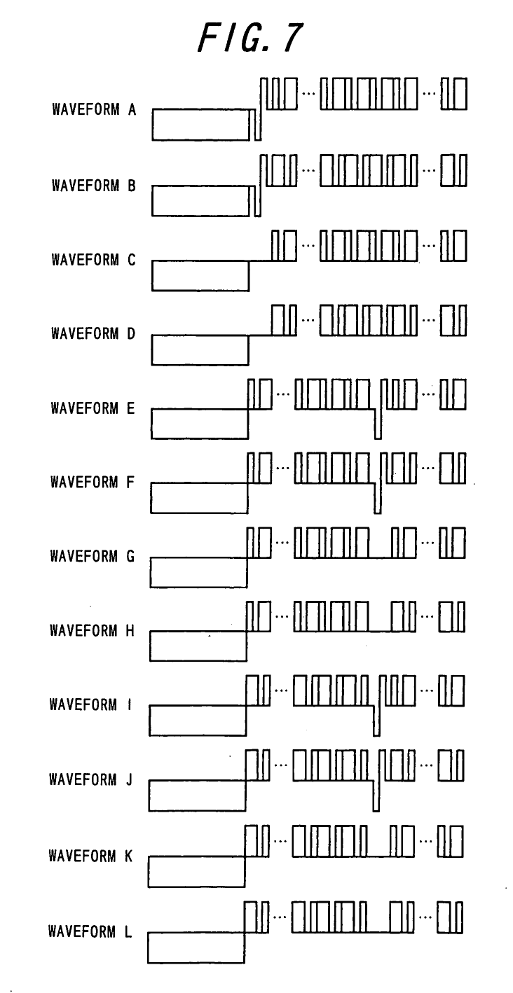

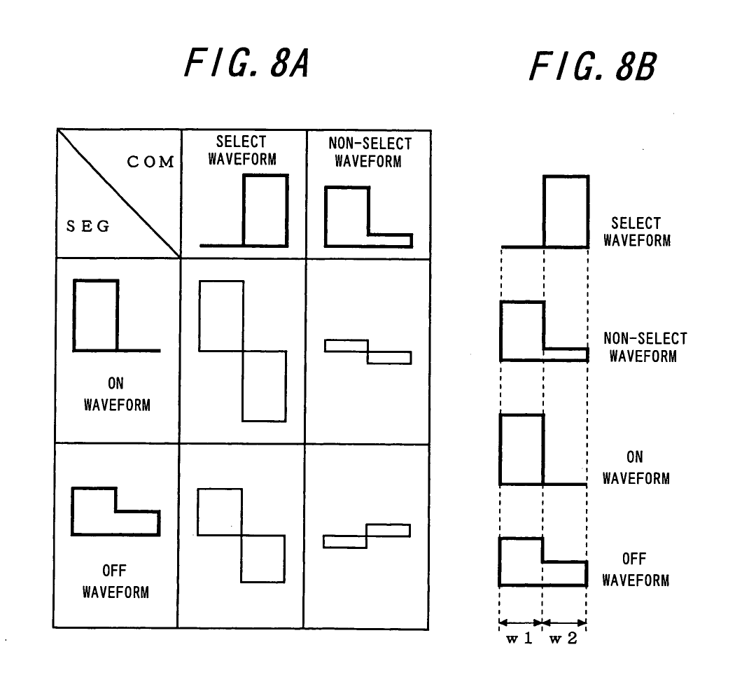

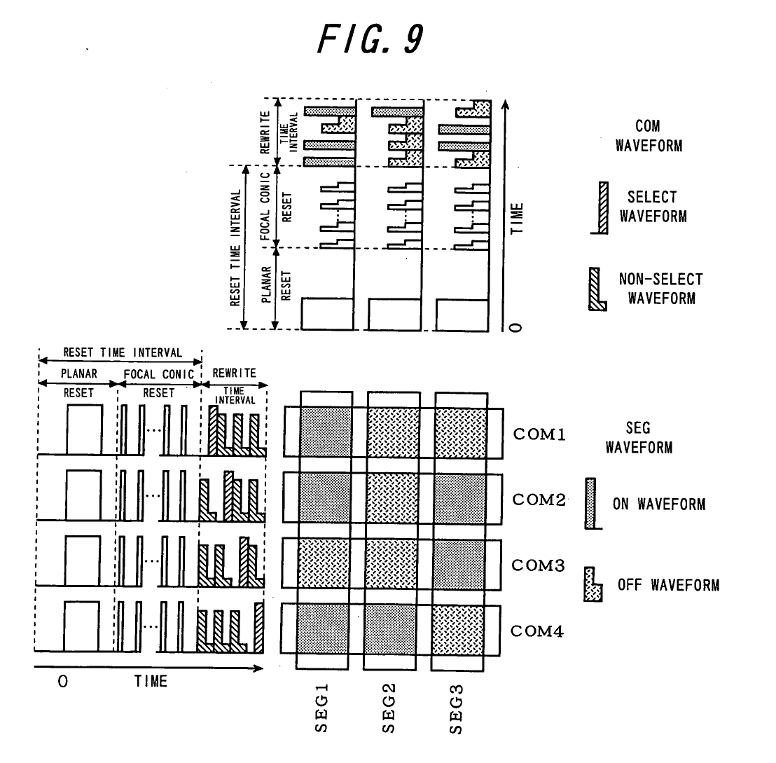

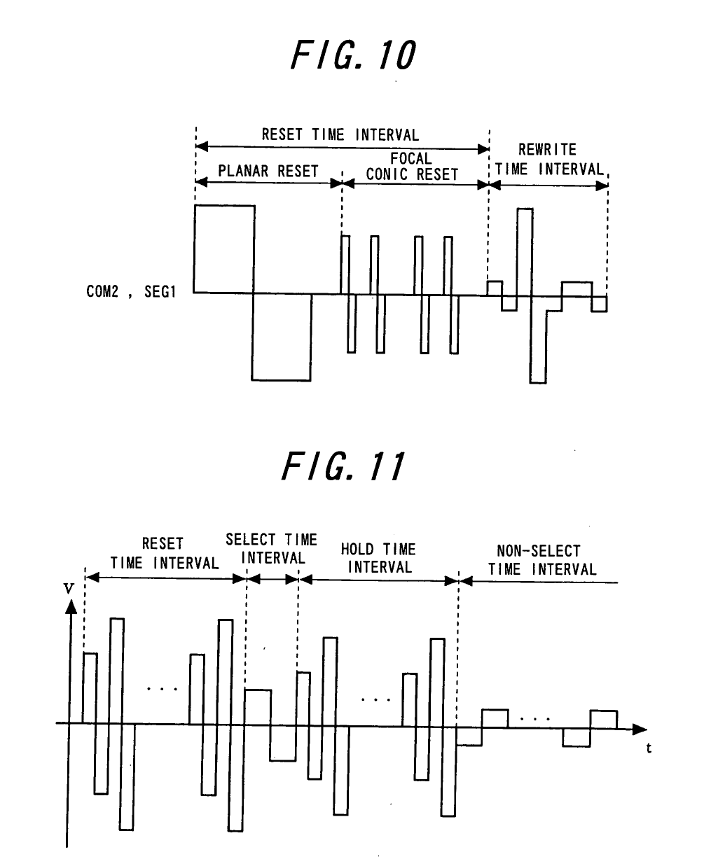

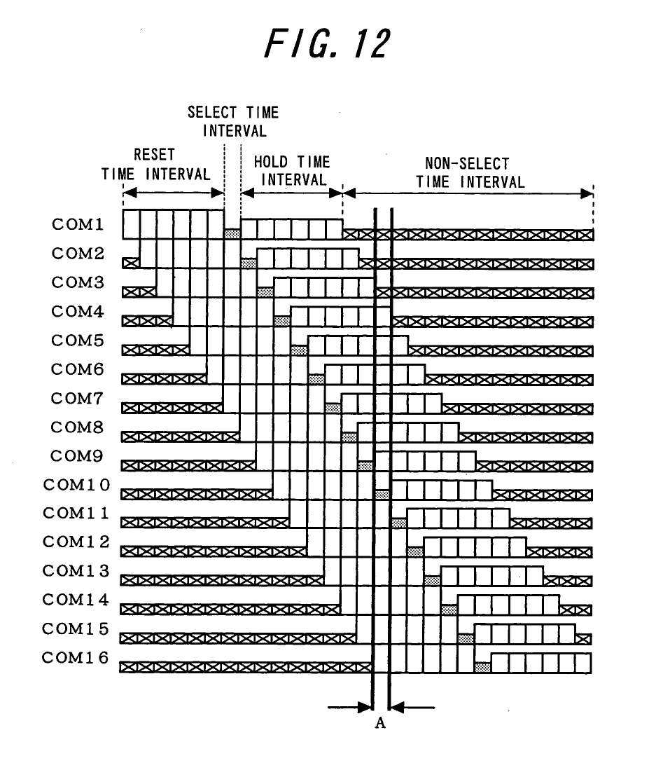

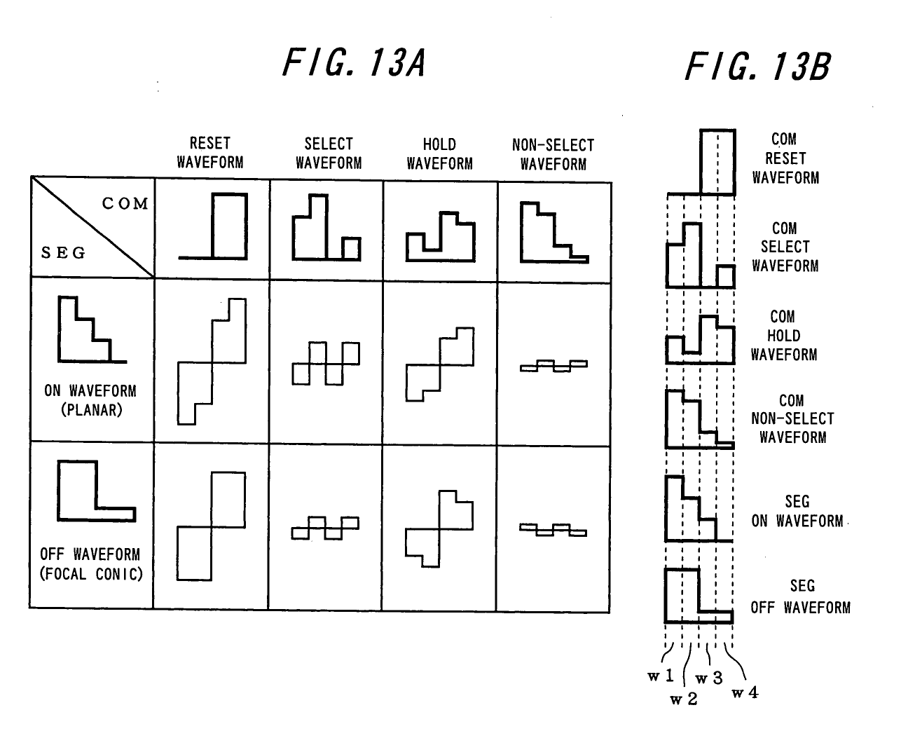

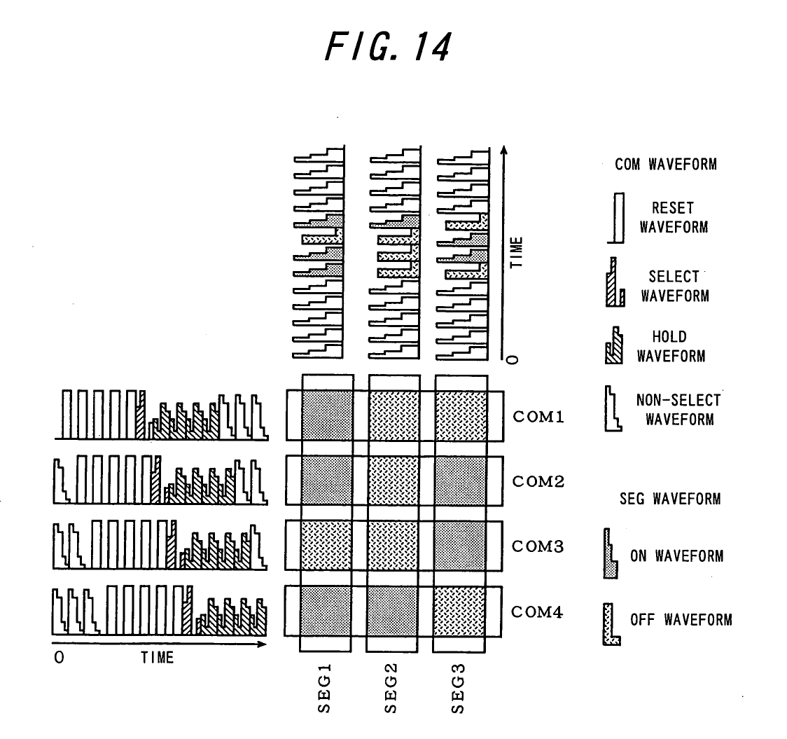

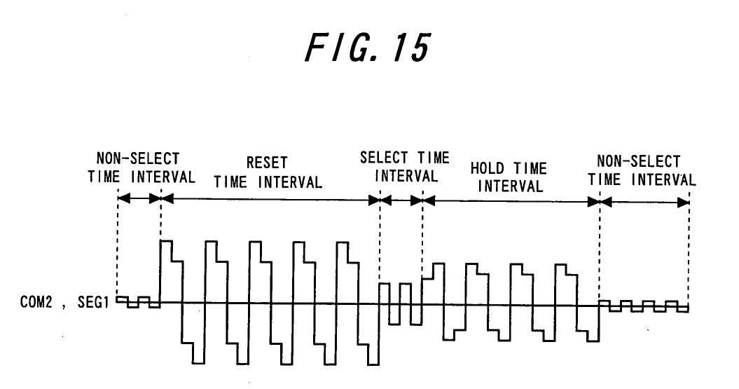

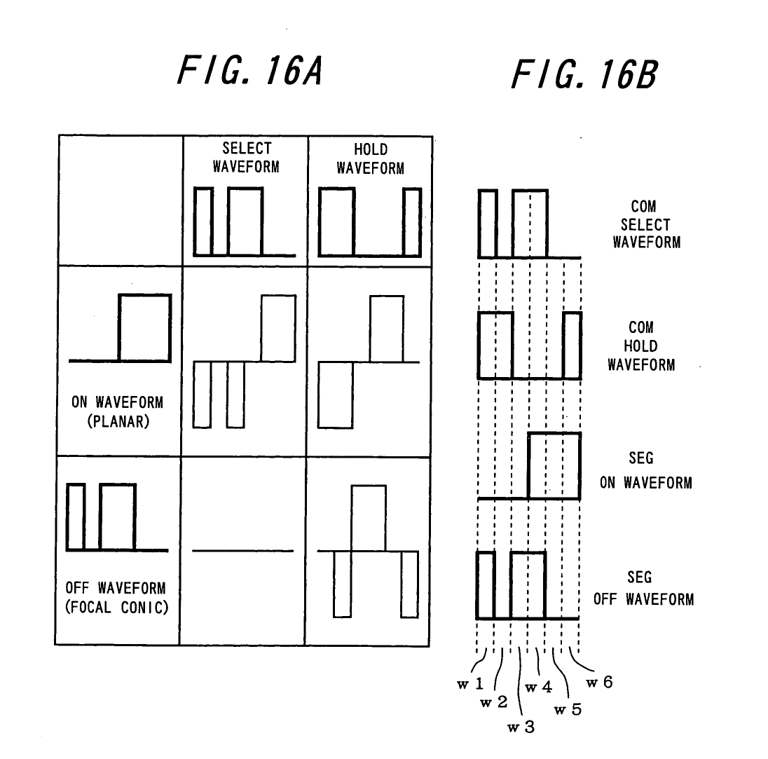

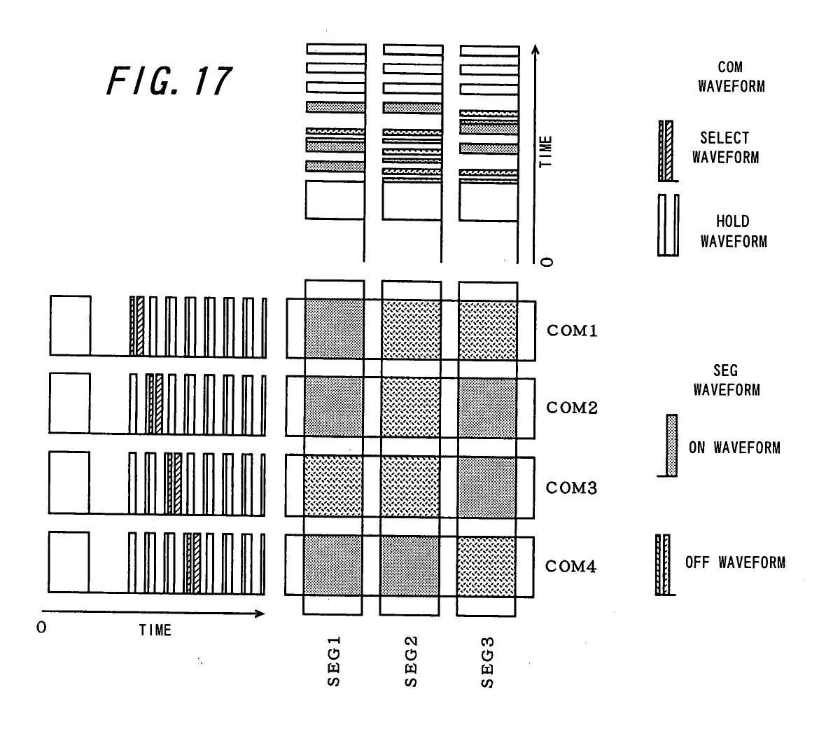

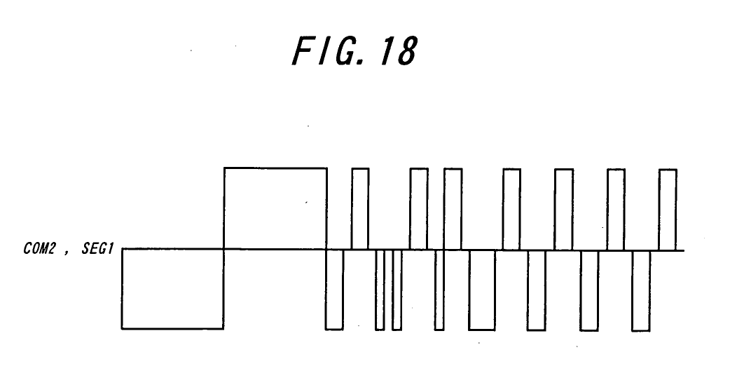

FIG. 7 shows that the difference signal between a common reset signal and a data reset signal, and the difference signal between a common hold signal and common select signal and a data signal are applied repeatedly plural times during a reset time interval, before hold time interval. select time interval, and behind hold time interval. Table 1 shows a reset condition, a repetition times of waveforms during each of the before hold time intervals, select time intervals, behind hold time interval, and the conditions of the data signals X and Y applied to the segment electrodes.

TABLE 1

| | | Before hold | | Select time | | Behind hold | | |
|---|---|---|---|---|---|---|---|---|
| | | time interval | | interval | | time interval | | Luminous |
| Waveform | Reset | Waveform | Times | Waveform | Times | Waveform | Times | reflectance |
| Waveform A | 29 V, | — | 0 | S(ON) | 1 | E(ON) | 120 | 18% |
| | 90 msec | | | | | | | |
| Waveform B | 29 V, | — | 0 | S(ON) | 1 | E(OFF) | 120 | 18% |
| | 90 msec | | | | | | | |
| Waveform C | 29 V, | — | 0 | S(OFF) | 1 | E(ON) | 120 | 3% |
| | 90 msec | | | | | | | |
| Waveform D | 29 V, | — | 0 | S(OFF) | 1 | E(OFF) | 120 | 3% |
| | 90 msec | | | | | | | |
| Waveform E | 29 V, | E(ON) | 99 | S(ON) | 1 | E(ON) | 21 | 18% |
| | 90 msec | | | | | | | |
| Waveform F | 29 V, | E(ON) | 99 | S(ON) | 1 | E(OFF) | 21 | 18% |
| | 90 msec | | | | | | | |
| Waveform G | 29 V, | E(ON) | 99 | S(OFF) | 1 | E(ON) | 21 | 3% |
| | 90 msec | | | | | | | |
| Waveform H | 29 V, | E(ON) | 99 | S(OFF) | 1 | E(OFF) | 21 | 3% |
| | 90 msec | | | | | | | |
| Waveform I | 29 V, | E(OFF) | 99 | S(ON) | 1 | E(ON) | 21 | 18% |
| | 90 msec | | | | | | | |
| Waveform J | 29 V, | E(OFF) | 99 | S(ON) | 1 | E(OFF) | 21 | 18% |
| | 90 msec | | | | | | | |
| Waveform K | 29 V, | E(OFF) | 99 | S(OFF) | 1 | E(ON) | 21 | 3% |
| | 90 msec | | | | | | | |
| Waveform L | 29 V, | E(OFF) | 99 | S(OFF) | 1 | E(OFF) | 21 | 3% |
| | 90 msec | | | | | | | |

As shown in Table 1, the valance of positive voltage and negative voltage applied to a liquid crystal display device is held assuming that W=1 msec in FIG. 3B, and a drive voltage V_{D}=29 volts in FIG. 3C, and the reset time interval is 75% (90 msec) of the total (120 msec) of the before hold time interval and behind hold time interval. The applied voltage waveforms are intended to drive the liquid crystal display device 10 comprising 100 common electrodes.

Luminous reflectances in the liquid crystal display device 10 by applying such DDS drive voltage waveforms to the liquid crystal display device are also shown in Table 1.

A cholesteric liquid crystal was caused to be a planar oriented state when the voltage waveforms A, B, E, F, I, and J were applied in which the data signal X was inputted when the common select voltage waveform was applied, and a cholesteric liquid crystal was caused to be a focal conic oriented state when the voltage waveforms C, D, G, H, K and L were applied in which the data signal Y was inputted when the common select voltage waveform was applied. The luminous reflectance was about 18% in the planar state, the luminous reflectance was about 3% in the focal conic state, and the contrast was about 6.

It is proved that a rewrite operation is possible at a 1 msec speed per common electrode on the assumption that W=1 msec in FIG. 3B.

Also, in a liquid crystal display device having a cholesteric liquid crystal different from that of above-described embodiment, the orientation of the cholesteric liquid crystal may be caused to be a planar state or focal conic state by regulating the width W of each signal shown in FIG. 3B and the voltage VD shown in FIG. 3C.

According to the present invention, a liquid crystal display device may be driven at a good contrast and at a higher speed than that of the conventional drive method by using the voltage waveforms shown in FIG. 3A.

1. A method for driving a cholesteric liquid crystal display device in which pixels are formed in a matrix manner by a plurality of common electrodes provided on one glass substrate, a plurality of segment electrodes provided in a direction orthogonal to that of the common electrodes on the other glass substrate arranged oppositely to the one glass substrate, and a cholesteric liquid crystal provided between the common electrodes and the segment electrodes, a planar state, focal conic state or intermediate state thereof of the liquid crystal being maintained by a memory characteristic when a voltage is not applied to the pixel, and the orientation of the liquid crystal being controlled by the difference between a voltage applied to the common electrode and a voltage applied to the segment electrode, the method comprising the steps of:
resetting the liquid crystal of all the pixels to a homeotropic state by applying a common reset signal and a data reset signal to all the common electrodes and all the segment electrodes, respectively, to apply a reset signal consisting of the difference between the common reset signal and the data reset signal to the liquid crystal of all the pixels;
determining the orientation of each liquid crystal forming all the pixels by the steps of,
selecting one of the common electrodes as a common selected electrode and others thereof as common non-selected electrodes,
applying a common select signal and common hold signal to the common selected electrode and common non-selected electrode, respectively, and applying a data signal to the segment electrode in synchronizing with the common select signal, thereby applying a select signal consisting of the difference between the common select signal and the data signal to the liquid crystal forming the pixel on the common selected electrode to determine the final orientation of the liquid crystal, and applying a hold signal consisting of the difference between the common hold signal and the data signal to the liquid crystal forming the pixel on the common non-selected electrode,
subsequently selecting next one of the common electrodes as a common selected electrode and others thereof as common non-selected electrodes to determine the final orientation of the liquid crystal forming the pixel on the common selected electrode by implementing the above steps, and
repeating the just above step; and
holding the orientation of the liquid crystal of all the pixels determined by the above steps applying the common hold signal and the data signal to all the common electrodes and all the segment electrodes, respectively, to apply a hold signal consisting of the common hold signal and the data signal to the liquid crystal of all the pixels;
wherein the common hold signal is 0 volts, and the common select signal and data signal each consist of two levels of voltages consisting of 0 volts and a voltage other than 0 volts.

2. A method for driving a cholesteric liquid crystal display device according to claim 1, wherein the total of each time interval during which the voltage other than 0 volts is applied to the common electrode is equal to the total of each time interval during which the voltage other than 0 volts is applied to the segment electrode.

3. A method for driving a cholesteric liquid crystal display device according to claim 2, wherein the time interval of the data signal other than 0 volts is in the range of 60-80% to the width of the data signal.

4. A method for driving a cholesteric liquid crystal display device according to claim 2 or 3, wherein the starting voltage of the data signal to cause the final orientation of the cholesteric liquid crystal to a planar state is equal to the starting voltage to cause the final orientation of the cholesteric liquid crystal to a focal conic state.

5. A method for driving a cholesteric liquid crystal display device according to the claim 2 or 3, wherein the data reset signal is always 0 volts.

6. A cholesteric liquid crystal display apparatus, comprising:
a liquid crystal display device in which a plurality of pixels are formed at portions crossed by a plurality of common electrode and a plurality of segment electrodes;
a common driver for applying drive voltage waveforms from the common electrodes to the cholesteric liquid crystal display device, the drive voltage waveforms including a common reset signal to cause the cholesteric liquid crystal to a homeotropic state and a common select signal to select the final orientation of the cholesteric liquid crystal;
a segment driver for applying drive voltage waveforms from the segment electrodes to the cholesteric liquid crystal display device, the drive voltage waveforms including a data signal to cause the final orientation of the cholesteric liquid crystal to a planar state and a data signal to cause the final orientation of the cholesteric liquid crystal to a focal conic state; and
a controller for controlling the common driver and segment driver;
wherein the controller controls the common and segment driver in such a way that a display content is rewritten by
switching two levels of voltages consisting 0 volts and a voltage other than 0 volts to apply voltages to all the common electrodes and all the segment electrodes,
resetting the liquid crystal of all the pixels to a homeotropic state by applying a common reset signal and a data reset signal to all the common electrodes and all the segment electrodes, respectively, and
selecting one of the common electrodes as a common selected electrode, applying a common select signal to the common selected electrode, applying 0 volts to others of the common electrodes, applying a data signal to the segment electrode in synchronizing with the common select signal, repeating these steps to apply the common select signal to all the common electrodes, and applying 0 volts and data signals to all the common electrodes and all the segment electrodes, respectively.

7. A cholesteric liquid crystal display apparatus according to claim 6, wherein the controller controls the common driver and segment driver in such a way that the total of the time intervals of the common drive voltage waveform other than 0 volts is equal to the total of the time intervals of the segment drive voltage waveform other than 0 volts.

8. A cholesteric liquid crystal display apparatus according to claim 6 or 7, wherein the controller controls the segment driver in such a way that the data reset signal is always 0 volts.

9. The cholesteric liquid crystal display apparatus according to claim 6 or 7, wherein the number of common electrodes forming the pixels of the liquid crystal display device is smaller than 160.
